(19) United States
(12) Patent Application Publication
(10) Pub. No.: US 2009/0130159 A1
(43) Pub. Date: May 21, 2009

(54) WATER-DISPERSIBLE NANOPARTICLE CONTAINING MICROBICIDE

(75) Inventor: Kazutaka OGIWARA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/271,139

(22) Filed: Nov. 14, 2008

(30) Foreign Application Priority Data
Nov. 16, 2007 (JP) 2007-297537

(51) Int. Cl. A01N 25/00; A01N 31/14; A01N 31/08; A01N 43/16; A01N 37/10

(52) U.S. Cl. 424/405; 514/718; 514/731; 514/456; 514/532; 514/774; 514/775; 514/776; 977/773

(57) ABSTRACT

It is an object of the present invention to provide a nanoparticle containing a microbicide and a biodegradable polymer, which is safe and excellent in terms of dispersion stability and has high transparency and good absorbability due to its small particle size. The present invention provides a water-dispersible nanoparticle, which comprises a microbicide and a biodegradable polymer.

### TECHNICAL FIELD

The present invention relates to water-dispersible nanoparticles. More specifically, the present invention relates to water-dispersible nanoparticles that are excellent in dispersion stability and contain a microbicide.

### BACKGROUND ART

Extensive applications of fine particle materials have been expected for biotechnology. In particular, the application of nanoparticle materials generated based on the advancement of nanotechnology to food, cosmetics, pharmaceutical products, and the like has been actively discussed. In this regard, the results of many studies have been reported.

For instance, regarding cosmetics, more obvious skin-improving effects have been required in recent years. Manufactures have been attempting to improve the functionality and usability of their own products and to differentiate their own products from competitive products by applying a variety of new technologies such as nanotechnology. In general, the stratum corneum serves as a barrier for the skin. Thus, medicines are unlikely to permeate therethrough into the skin. In order to obtain sufficient skin-improving effects, it is essential to improve the skin permeability of active ingredients. In addition, it is difficult to formulate many active ingredients due to poor preservation stability or tendency to result in skin irritancy, although they are highly effective to the skin. In order to solve the above problems, a variety of fine particle materials have been under development for the improvement of transdermal absorption and preservation stability, reduction of skin irritancy, and the like. Recently, a variety of fine particle materials such as ultrafine emulsions and liposomes have been studied (e.g. Mitsuhiro Nishida, Fragrance Journal, Nov. 17, 2005)

Hitherto, it has been usual to add oil-based components to water-based cosmetics. However, since oil-based components are water-insoluble or weakly water-soluble, it has been common to mix an oil-based component, which is a so-called emulsified product, into an aqueous medium with the use of a certain emulsifying means. Light scattering of emulsified products depends on particle size. Thus, in some cases, emulsified products and foods or cosmetics containing emulsified products have cloudy appearances, which is not preferable. Therefore, it has been desired to miniaturize the particle size of an emulsified product to such an extent that the light scattering intensity becomes very low. In addition, emulsified products are generally in a metastable state. In such state, the particle size increases during storage and long-term storage results in separation, which are seriously problematic. In the cases of beverages, adherence of an aggregate of oil droplets to container walls and neck ring formation with such an aggregate are examples of oil droplet separation phenomenon observed in emulsified products.

As described above, many fine particle materials used for foods or cosmetics are related to emulsified products. Meanwhile, in recent years, polymer micelles have been gaining attention in the fields of pharmaceutical products and cosmetics (e.g. JP Patent Publication (Kokai) No 2002-308728 A). Polymer micelles are characterized by large drug contents, high water solubility, high structural stability, non-accumulative properties, functional separation properties, and the like. Studies have been conducted on inclusion of a drug into a micelle structure of an amphiphilic polymer for administration into the blood, and the resulting product has been under clinical trials (e.g. Y. Mizumura et al., Jap. J. Cancer Res., 93, 1237 (2002)).

In the cases of emulsified products, surfactant-induced electrostatic interactions are used, and this always causes stability problems, such as a droplet separation phenomenon. On the other hand, polymer micelles are structurally formed with covalent bonds, which is advantageous in terms of stability. Further, if miniaturization (nanoparticle formation) of polymer micelles can be achieved, sufficient transparency is obtained upon water dispersion. However, biodegradable polymers, and particularly, natural polymers such as proteins, are highly safe for use, as compared with generally used synthetic surfactants. Therefore, nanoparticles made of biodegradable polymers have been awaited.

Meanwhile, microbicides are widely added, as skin-roughness-preventive, skin dietary supplement, or hair growth-promoting/hair-increasing components, to products such as cosmetics, including lotions, creams, and emulsions, quasi-drugs, and externally applied pharmaceutical products. They are categorized as synthetic substances, plant extracts, vitamins, sugars, or the like. However, such extracts are extracted from organic solvents such as ethanol and 1,3-butylene glycol. Thus, it has been known that it is not always possible to keep such extracts in a stable state when adding them to water dispersions. In addition, it has been known that products other than extracts are also very weakly water-soluble. Addition of such components can be achieved by controlling the contents of organic solvents from 20% to less than 100% or by emulsifying such components with surfactants, for example. However, it has been known that such organic solvents cause excessive skin degreasing, and that surfactants and the like induce skin irritation or allergy.

### DISCLOSURE OF THE INVENTION

It is an object of the present invention to solve the above problems of the conventional techniques. Specifically, it is an object of the present invention to provide a nanoparticle containing a microbicide and a biodegradable polymer, which is safe and excellent in terms of dispersion stability and has high transparency and good absorbability due to its small particle size.

As a result of intensive studies to achieve the above object, the present inventors have found that a water-dispersible nanoparticle can be prepared by mixing a poorly water-soluble microbicide with a biodegradable polymer. The present invention has been completed based on the above findings.

Thus, the present invention provides a water-dispersible nanoparticle, which comprises a microbicide and a biodegradable polymer.

Preferably, in the nanoparticle of the present invention, the content of the microbicide is 0.1% to 100% by weight with respect to the weight of the biodegradable polymer.

Preferably, the average particle size is 10 to 1000 nm.

Preferably, the microbicide is an ionic substance or a fat-soluble substance.

Preferably, the microbicide is a cosmetic component, a functional food component, a quasi-drug component, or a pharmaceutical product component.

Preferably, the microbicide is at least one selected from the group consisting of hinokitiol, phenoxyethanol, thymol, cineole, isopropylmethylphenol, and methyl paraoxybenzoate.

Preferably, the biodegradable polymer is a protein.

Preferably, the protein is at least one selected from the group consisting of collagen, gelatin, acid-treated gelatin, albumin, ovalbumin, casein, sodium casein, transferrin, globulin, fibroin, fibrin, laminin, fibronectin, and vitronectin.

Preferably, the protein is subjected to a crosslinking treatment during and/or after nanoparticle formation.

Preferably, a transglutaminase is used for the crosslinking treatment.

The present invention further provides a casein nanoparticle which is prepared by the following steps (a) to (c) of:
(a) mixing casein with a basic aqueous medium at a pH of from 8 to less than 11;
(b) adding at least one microbicide to the solution obtained in step (a); and
(c) injecting the solution obtained in step (b) into an acidic aqueous medium at a pH of 3.5 to 7.5.

The present invention further provides a casein nanoparticle which is prepared by the following steps (a) to (c) of:
(a) mixing casein with a basic aqueous medium at a pH of from 8 to less than 11;
(b) adding at least one microbicide to the solution obtained in step (a); and
(c) decreasing the pH of the solution obtained in the step (b) to a pH value that is pH 1 or more away from the isoelectric point, while stirring the solution.

The present invention further provides a drug delivery agent which comprises the aforementioned nanoparticle of the present invention.

The particle of the present invention which contains a microbicide is a nanoparticle, and thus it has good absorbability and high transparency. The nanoparticle of the present invention is a nanoparticle comprising a biodegradable polymer such as a protein, and thus the structure thereof is highly stable. In addition, the particle can be produced without using a chemical crosslinking agent or synthetic surfactant, and thus it is highly safe. Further, dispersion of a hydrophobic microbicide in the nanoparticle can be achieved. Thus, there is no need to add a large volume of ethanol and therefore skin irritation caused by ethanol can be reduced.

### BRIEF DESCRIPTION OF THE DRAWING

FIG. 1 shows the results obtained by measuring the hair growth-promoting action of the agents of the present invention and those of comparative examples.

### BEST MODE FOR CARRYING OUT THE INVENTION

The embodiments of the present invention will be more specifically described below.

The water-dispersible nanoparticle of the present invention is characterized in that it comprises a poorly water-soluble microbicide and a biodegradable polymer.

Specific examples of a microbicide that can be used in the present invention will be given below. However, the microbicide is not particularly limited thereto, as long as it can exhibit microbicidal effects. The microbicide can be appropriately selected from cosmetic components, functional food components, quasi drug components, or pharmaceutical components. In addition, the term “microbicide” is used to mean that a certain product has antibacterial action because of a wide range of antibacterial spectrum.

A microbicide is preferably an ionic substance or a fat-soluble substance, and is particularly preferably a fat-soluble substance. The type of such a microbicide includes a synthetic product, a plant extract, and the like.

Specific examples of the microbicide include acrinol, sulfur, calcium gluconate, chlorhexidine gluconate, sulfamine, mercurochrome, lactoferrin or a hydrolyzed product thereof, an alkyldiaminoethylglycine chloride solution, triclosan, sodium hypochlorite, chloramine T, chloride of lime, an iodine compound, iodoform, sorbic acid or a salt thereof, propionic acid or a salt thereof, salicylic acid, resorcin, dehydroacetic acid, parahydroxybenzoic acid esters, undecylenic acid, thiamine dilaurylsulfate, thiamine dilaurylnitrate, phenol, 2,2,4-trichlor-2-hydroxyphenol, cresol, p-chlorophenol, p-chloro-m-xylenol, p-chloro-m-cresol, thymol, phenethyl alcohol, o-phenylphenol, Irgasan CH3565, Halocarban, hexachlorophene, chlorohexidine, ethanol, methanol, isopropyl alcohol, benzyl alcohol, ethylene glycol, propylene glycol, 2-phenoxyethanol, 1,2-pentanediol, zinc pyrithione, chlorobutanol, isopropylmethylphenol, nonionic surfactants (polyoxyethylene lauryl ether, polyoxyethylene nonyl phenyl ether, polyoxyethylene octyl phenyl ether, etc.), amphoteric surfactants, anionic surfactants (sodium lauryl sulfate, lauroylsarcosine potassium, etc.), cationic surfactants (cetyltrimethylammonium bromide, benzalkonium chloride, benzethonium chloride, methylrosanilinium chloride), formaldehyde, hexamine, brilliant green, malachite green, crystal violet, Germal, photosensitizing dye 101, photosensitizing dye 201 photosensitizing dye 401, an N-long chain acyl basic amino acid derivative and an acid-added salt thereof, zinc oxide, hinokitiol, Sophora root, and propolis. Preferred examples include hinokitiol, phenoxyethanol, thymol, cineol, isopropylmethylphenol, and methyl paraoxybenzoate.

These microbicides are widely used as antibacterial, hair growth-promoting, and hair-increasing components, and are added to cosmetic products such as a lotion, a cream or an emulsion, quasi drugs, or external medical preparations. The microbicide used in the present invention may be used singly or in combination of two or more.

In the nanoparticle of the present invention, the content of the microbicide is preferably 0.1% to 100% by weight with respect to the weight of the biodegradable polymer, and more preferably 0.1% to 50% by weight with respect to the weight of the biodegradable polymer.

The average particle size of the nanoparticle of the present invention is generally 1 to 1000 nm, preferably 10 to 1000 nm, more preferably 10 to 500 nm, further preferably 15 to 400 nm.

The biodegradable polymer may be a protein, or may be a biodegradable synthetic polymer.

The type of biodegradable polymer is not particularly limited. However, a protein having a lysine residue and a glutamine residue is preferable. In addition, such protein having a molecular weight of approximately 10,000 to 1,000,000 is preferably used. The origin of the protein is not particularly limited. However, a human-derived protein is preferably used. Specific examples of a protein that can be used include at least one selected from the group consisting of collagen, gelatin, acid-treated gelatin, albumin, ovalbumin, casein, sodium casein, transferrin, globulin, fibroin, fibrin, laminin, fibronectin, and vitronectin. However, the compound used in the present invention is not limited to the aforementioned compounds. In addition, the origin of the protein is not particularly limited. Thus, bovine, swine or fish, as well as recombinant protein of any thereof, can be used. Examples of recombinant gelatin that can be used include, but are not limited to, gelatins described in EP1014176 A2 and U.S. Pat. No. 6,992,172. Among them, casein, acid-treated gelatin, collagen, or albumin is preferable. Further, casein or acid-treated gelatin is most preferable. When casein is used in the present invention, the origin of the casein is not particularly limited. Casein may be milk-derived or bean-derived. Any of α-casein, β-casein, γ-casein, and κ-casein, as well as a mixture thereof, can be used. Caseins may be used alone or in combinations of two or more.

Proteins used in the present invention may be used alone or in combinations of two or more. Further, examples of the biodegradable synthetic polymer include polylactic acid, and poly(lactic-co-glycolic acid) (PLGA).

According to the present invention, a protein can be subjected to crosslinking treatment during and/or after nanoparticle formation. For the crosslinking treatment, an enzyme can be used. Any enzyme may be used without particular limitation as long as it has been known to have an action of causing protein crosslinking. Among such enzymes, transglutaminase is preferable.

Transglutaminase may be derived from a mammal or a microorganism. A recombinant transglutaminase can be used. Specific examples thereof include the Activa series by Ajinomoto Co., Inc., commercially available mammalian-derived transglutaminase serving as a reagent, such as guinea pig liver-derived transglutaminase, goat-derived transglutaminase, rabbit-derived transglutaminase, or human-derived recombinant transglutaminase produced by, for example, Oriental Yeast Co., Ltd., Upstate USA Inc., and Biodesign International.

The amount of an enzyme used for the crosslinking treatment in the present invention can be adequately determined depending upon protein type. In general, an enzyme can be added in a weight that is 0.1% to 100% and preferably approximately 1% to 50% of the protein weight.

The duration for an enzymatic crosslinking reaction can be adequately determined depending upon protein type and nanoparticle size. However, in general, the reaction can be carried out for 1 to 72 hours, and preferably 2 to 24 hours.

The temperature for an enzymatic crosslinking reaction can be adequately determined depending upon protein type and nanoparticle size. In general, the reaction can be carried out at 0° C. to 80° C. and preferably at 25° C. to 60° C.

Enzymes used in the present invention may be used alone or in combinations of two or more.

Nanoparticles of the present invention can be prepared in accordance with Patent Document: JP Patent Publication (Kokai) No. 6-79168 A (1994); or C. Coester, Journal Microcapsulation, 2000, vol. 17, pp. 187-193, provided that an enzyme is preferably used instead of glutaraldehyde for a crosslinking method.

In addition, according to the present invention, the enzymatic crosslinking treatment is preferably carried out in an organic solvent. The organic solvent used herein is preferably an aqueous organic solvent such as ethanol, isopropanol, acetone, or THF.

It is also possible to add at least one component selected from the group consisting of lipids (e.g., phospholipid), anionic polysaccharides, cationic polysaccharides, anionic proteins, cationic proteins, and cyclodextrin to the water-dispersible nanoparticle of the present invention. The amounts of lipid (e.g. phospholipid), anionic polysaccharide, cationic polysaccharide, anionic protein, cationic protein, and cyclodextrin to be added are not particularly limited. However, they can be added usually in a weight that is 0.1% to 100% of the protein weight. In the case of the drug delivery agent of the present invention, it is possible to adjust the release rate by changing the ratio of the above components to the protein.

Specific examples of phospholipids that can be used in the present invention include, but are not limited to, the following compounds: phosphatidylcholine (lecithin), phosphatidylethanolamine, phosphatidylserine, phosphatidylinositol, phosphatidylglycerol, diphosphatidylglycerol, and sphingomyelin.

Anionic polysaccharides that can be used in the present invention are polysaccharides having an acidic polar group such as a carboxyl group, a sulfate group, or a phosphate group. Specific examples thereof include, but are not limited to, the following compounds: chondroitin sulfate, dextran sulfate, carboxymethyl cellulose, carboxymethyl dextran, alginic acid, pectin, carrageenan, fucoidan, agaropectin, porphyran, karaya gum, gellan gum, xanthan gum, and hyaluronic acids.

Cationic polysaccharides that can be used in the present invention are polysaccharides having a basic polar group such as an amino group. Examples thereof include, but are not limited to, the following compounds: polysaccharides such as chitin or chitosan, which comprise, as a monosaccharide unit, glucosamine or galactosamine.

Anionic proteins that can be used in the present invention are proteins and lipoproteins having a more basic isoetectric point than the physiological pH. Specific examples thereof include, but are not limited to, the following compounds: polyglutamic acid, polyaspartic acid, lysozyme, cytochrome C, ribonuclease, trypsinogen, chymotrypsinogen, and α-chymotrypsin.

Cationic proteins that can be used in the present invention are proteins and lipoproteins having a more acidic isoelectric point than the physiological pH. Specific examples thereof include, but are not limited to, the following compounds: polylysine, polyarginine, histone, protamine, and ovalbumin.

In the present invention, it is possible to use casein nanoparticles prepared by the following steps (a) to (c) of:
(a) mixing casein with a basic aqueous medium at a pH of from 8 to less than 11;
(b) adding at least one microbicide to the solution obtained in step (a); and
(c) injecting the solution obtained in step (b) into an acidic aqueous medium at a pH of 3.5 to 7.5.

Furthers according to the present invention, it is possible to use casein nanoparticles prepared by the following steps (a) to (c) of:
(a) mixing casein with a basic aqueous medium at a pH of from 8 to less than 11;
(b) adding at least one microbicide to the solution obtained in step (a); and
(c) decreasing the pH of the solution obtained in the step (b) to a pH value that is pH 1 or more away from the isoelectric point, while stirring the solution.

According to the present invention, it is possible to prepare casein nanoparticles of desired sizes. Also, with the use of interaction between a hydrophobic microbicide and a casein hydrophobic domain, it is possible for casein nanoparticles to contain the microbicide. In addition, it was found that such particles remain stable in an aqueous solution.

Further, it was found that a particle mixture of casein and ionic polysaccharide or another ionic protein contains an ionic microbicide.

The method for preparing casein nanoparticles of the present invention involves a method wherein casein is mixed with a basic aqueous medium solution and the solution is injected into another acidic aqueous medium, and a method wherein casein is mixed with a basic aqueous medium solution and the pH of the solution is lowered during stirring, for example.

The method wherein casein is mixed with a basic aqueous medium solution and the solution is injected into another acidic aqueous medium is preferably carried out using a syringe for convenience. However, there is no particular limitation as long as the injection rate, solubility, temperature, and stirring conditions are satisfied. Injection can be carried out usually at an injection rate of 1 mL/min to 100 mL/min. The temperature of the basic aqueous medium can be adequately determined. In general, the temperature is 0° C. to 80° C. and preferably 25° C. to 70° C. The temperature of an acidic aqueous medium can be adequately determined. In general, the temperature can be 0° C. to 80° C. and preferably 25° C. to 60° C. The stirring rate can be adequately determined. However, in general, the stirring rate can be 100 rpm to 3000 rpm and preferably 200 rpm to 2000 rpm.

In the method wherein casein is mixed with a basic aqueous medium solution and the pH of the medium is lowered during stirring, it is preferable to add acid dropwise for convenience. However, there is no particular limitation as long as solubility, temperature, and stirring conditions are satisfied. The temperature of a basic aqueous medium can be adequately determined. However, in general, the temperature can be 0° C. to 80° C. and preferably 25° C. to 70° C. The stirring rate can be adequately determined. However, in general, the stirring rate can be 100 rpm to 3000 rpm and preferably 200 rpm to 2000 rpm.

The aqueous medium that can be used for the present invention is an aqueous solution or a buffer comprising an organic acid or base or an inorganic acid or base.

Specific examples thereof include, but are not limited to, aqueous solutions comprising: organic acids such as citric acid, ascorbic acid, gluconic acid, carboxylic acid, tartaric acid, suceinic acid, acetic acid, phthalic acid, trifluoroacetic acid, morpholinoethanesulfonic acid, and 2-[4-(2-hydroxyethyl)-1-piperazinyl]ethanesulfonic acid; organic bases such as tris(hydroxymethyl), aminomethane, and ammonia; inorganic acids such as hydrochloric acid, perchloric acid, and carbonic acid; and inorganic bases such as sodium phosphate, potassium phosphate, calcium hydroxide, sodium hydroxide, potassium hydroxide, and magnesium hydroxide.

The concentration of an aqueous medium used in the present invention is preferably approximately 10 mM to 1 M, and more preferably approximately 20 mM to 200 mM.

The pH of a basic aqueous medium used in the present invention is preferably 8 or more and less than 11, more preferably pH 10 to 11 When the pH is excessively high, there is concern regarding hydrolysis or risks in handling. Thus, the pH is preferably in the above range.

According to the present invention, the temperature at which casein is mixed with a basic aqueous medium at pH of 8 or more and less than 11 is preferably 0° C. to 90° C., more preferably 10° C. to 80° C., and further preferably 20° C. to 70° C.

The pH of an acidic aqueous medium used in the present invention is preferably 3.5 to 7.5 and more preferably 5 to 6. If the pH is out of the aforementioned range, there is a tendency where the particle size becomes large.

The nanoparticle of the present invention comprises a microbicide. When the microbicide is an active substance, such a casein nanoparticle comprising the active substance can be administered to the affected part for use. Specifically, the casein nanoparticle of the present invention is useful as a drug delivery agent.

Preferred examples of administration method of the nanoparticle of the present invention may include transdermal administration, transmucosal administration, and injection into blood, body cavity or lymph. More preferred examples include transdermal administration, transmucosal administration.

The use of the drug delivery agent of the present invention is not particularly limited in the present invention, and can be used as, for example, a transdermal agent, a local therapeutic agent, an oral therapeutic agent, an intracutaneous injection, a subcutaneous injection, an intramuscular injection, intravenous injection, a cosmetic product, a quasi-drug, a functional food or a supplement.

The water-dispersible nanoparticle of the present invention may also comprise additives. The types of such additives are not particularly limited. One or more types selected from among a moisturizing agent, a softening agent, an anti-inflammatory agent, a transdermal absorption enhancer, a soothing agent, a preservative, an antioxidant, a coloring agent, a thickener, an aroma chemical, and a pH adjuster, can be used.

Specific examples of moisturizing agents that can be used in the present invention include, but are not limited to, the following compounds: agar, diglyceria, distearyldimonium hectorite, butylene glycol, polyethylene glycol, propylene glycol, hexylene glycol, Coix lachrma-jobi extract, vaseline, urea, hyalaronic acid, ceramide, Lipidure, isoflavone, amino acid, collagen, mucopolysaccharide, fucoidan, lactoferrin, sorbitol, chitin/chitosan, malic acid, glucuronic acid, placenta extract, seaweed extract, moutan cortex extract, sweet tea extract, hypericum extract, coleus extract, Euonymus japonicus extract, safflower extract, Rosa rugosa flower extract, Polyporus sclerotium extract, hawthorn extract, rosemary extract, duke extract, chamomile extract, Lamium album extract, Litchi Chinensis extract, Achillea millefolium extract, aloe extract, marronnier extract, Thujopsis dolabrata extract, Fucus extract, Osmoin extract, oat bran extract, tuberosa polysaccharide, Cordyceps sinensis (plant worm) extract, barley extract, orange extract, Rehmannia glutinosa extract, zanthoxylumb extract, and Coix lachrma-jobi extract.

Specific examples of softening agents that can be used in the present invention include, but are not limited to, the following compounds: glycerin, mineral oil, and emollient ingredients (e.g., isopropyl isostearate, polyglyceryl isostearate, isotridecyl isononanoate, octyl isononanoate, oleic acid, glyceryl oleate, cocoa butter, cholesterol, mixed fatty acid triglyceride, dioctyl succinate, sucrose tetrastearate triacetate, cyclopentasiloxane, sucrose distearate, palmitateoctyl, octyl hydroxystearate, arachidyl behenate, sucrose polybehenate, polymethylsilsesquioxane, myristyl alcohol, cetyl myristate, myristyl myristate, and hexyl laurate).

Examples of anti-inflammatory agents include: compounds and derivatives and salts thereof selected from the group consisting of azulene, guaiazulene, diphenhydramine hydrochloride, hydrocortisone acetate, predonisolone, glycyrrhizic acid, glycyrrhetinic acid, mefenamic acid, phenylbutazone, indomethacin, ibuprofen, and ketoprofen; plant extracts selected from the group consisting of Scutellariae radix extract, Artemisia capillaris extract, balloonflower (Platycodon grandiflorus) extract, Armeniacae semen extract, gaxdenia extract, Sasa veitchii extract, gentiana extract, comfrey extract, white birch extract, mallow extract, Persicae semen extract, peach leaf extract, and Eriobotryae folium extract; proteins; polysaccharides; and animal extract.

Specific examples of transdermal absorption enhancers that can be used in the present invention include, but are not limited to, the following compounds: ethanol, isopropyl myristate, citric acid, squalane, oleic acid, menthol, N-methyl-2-pyrrolidone, diethyl adipate, diisopropyl adipate, diethyl sebacate, diisopropyl sebacate, isopropyl palmitate, oleic acid isopropyl, oleic acid octyldodecyl, isostearyl alcohol, 2-octyldodecanol, urea, vegetable oil, and animal oil.

Specific examples of soothing agents that can be used in the present invention include, but are not limited to, the following compounds: benzyl alcohol, procaine hydrochloride, xylocaine hydrochloride, and chlorobutanol.

Specific examples of preservatives that can be used in the present invention include, but are not limited to, the following compounds: benzoic acid, sodium benzoate, paraben, ethylparaben, methylparaben, propylparaben, butylparaben, potassium sorbate, sodium sorbate, sorbic acid, sodium dehydroacetate, hydrogen peroxide, formic acid, ethyl formate, sodium hypochlorite, propionic acid, sodium propionate, calcium propionate, pectin degradation products, polylysine, phenol, isopropylmethyl phenol, orthophenylphenol, phenoxyethanol, resorcin, thymol, thiram, and tea tree oil.

Specific examples of antioxidants that can be used in the present invention include, but are not limited to, the following compounds: vitamin A, retinoic acid, retinol, retinol acetate, retinol palmitate, retinyl acetate, retinyl palmitate, tocopheryl retinoate, vitamin C and derivatives thereof, kinetin, β-carotene, astaxanthin, lutein, lycopene, tretinoin, vitamin E, α-lipoic acid, coenzyme Q10, polyphenol, SOD, and phytic acid.

Specific examples of coloring agents that can be used in the present invention include, but are not limited to, the following compounds krill pigment, orange dye, cacao dye, kaoline, carmines, ultramarine blue, cochineal dye, chrome oxide, iron oxide, titanium dioxide, tar dye, and chlorophyll.

Specific examples of thickeners that can be used in the present invention include, but are not limited to, the following compounds: quince seed, carrageenan, gum arabic, karaya gum, xanthan gum, gellan gum, tamarind gum, locust bean gum, gum traganth, pectin, starch, cyclo dextrin, methylcellulose, ethylcellulose, carboxymethylcellulose, sodium alginate, polyvinyl alcohol, polyvinyl pyrrolidone, carboxyvinyl polymer, and sodium polyacrylate.

Specific examples of aroma chemicals that can be used in the present invention include, but are not limited to, the following compounds: musk, acacia oil, anise oil, ylang ylang oil, cinnamon oil, jasmine oil, sweet orange oil, spearmint oil, geranium oil, thyme oil, neroli oil, mentha oil, hinoki (Japanese cypress) oil, fennel oil, peppermint oil, bergamot oil, lime oil, lavender oil, lemon oil, lemongrass oil, rose oil, rosewood oil, anisaldehyde, geraniol, citral, civetone, muscone, limonene, and vanillin.

Specific examples of pH adjusters that can be used in the present invention include, but are not limited to, the following compounds: sodium citrate, sodium acetate, sodium hydroxide, potassium hydroxide, phosphoric acid, and succinic acid.

The dose of the nanoparticle of the present invention can be adequately determined depending upon type and amount of active ingredient and upon user weight and condition, for example. The dose for single administration is generally approximately 10 μg to 100 mg/kg and preferably 20 μg to 50 mg/kg. When used for transderxmal administration or transmucosal administration, the dose is generally approximately 1 μg to 50 mg/cm² and preferably 2.5 μg to 10 mg/cm².

The present invention is hereafter described in greater detail with reference to the following examples, although the technical scope of the present invention is not limited thereto.

### EXAMPLES

### Example 1

10 mg of milk-derived casein Na (manufactured by Wako Pure Chemical Industries, Ltd.) was mixed with 1 mL of 50 mM phosphate buffer (pH 9). 8.5 mg of Hinokitiol (manufactured by Wako Pure Chemical Industries, Ltd.) was dissolved in 0.1 mL of ethanol. The hinokitiol solution was added dropwise to the casein solution during stirring. 1 mL of the resulting liquid mixture was injected into 10 mL of 200 mM phosphate buffer water (pH 5) with the use of a microsyringe at an external temperature of 40° C. during stirring at 800 rpm. Thus, a water dispersion of casein nanoparticles containing hinokitiol was obtained. The volume average particle size of the obtained casein particles was measured with a “Zetasizer Nano” (manufactured by Sysmex) and was found to be 20.0 nm.

### Example 2

Nanoparticles were prepared as in Example 1, except that 17.0 mg of hinokitiol (manufactured by Wako Pure Chemical Industries, Ltd.) was dissolved in 0.1 mL of ethanol. The volume average particle size of the obtained casein particles was measured with a “Zetasizer Nano” (manufactured by Sysmex) and was found to be 35.0 nm.

### Example 3

Nanoparticles were prepared as in Example 1, except that 8.5 mg of phenoxyethanol (manufactured by Wako Pure Chemical Industries, Ltd.) was dissolved in 0.1 mL of ethanol. The volume average particle size of the obtained casein particles was measured with a “Zetasizer Nano” (manufactured by Sysmex) and was found to be 28.0 nm.

### Example 4

Nanoparticles were prepared as in Example 1, except that 17 mg of thymol (manufactured by Wako Pure Chemical Industries, Ltd.) was dissolved in 0.1 mL of ethanol. The volume average particle size of the obtained casein particles was measured with a “Zetasizer Nano” (manufactured by Sysmex) and was found to be 20.5 run.

### Example 5

Nanoparticles were prepared as in Example 1, except that 8.5 mg of cineole (manufactured by Wako Pure Chemical Industries, Ltd.) was dissolved in 0.1 mL of ethanol. The volume average particle size of the obtained casein particles was measured with a “Zetasizer Nano” (manufactured by Sysmex) and was found to be 20.8 nm.

### Example 6

Nanoparticles were prepared as in Example 1, except that 8.5 mg of isopropylmethylphenol (manufactured by Wako Pure Chemical Industries, Ltd.) was dissolved in 0.1 mL of ethanol. The volume average particle size of the obtained casein particles was measured with a “Zetasizer Nano” (manufactured by Sysmex) and was found to be 28.0 nm.

### Example 7

Nanoparticles were prepared as in Example 1 except that 20 mg of methyl paraoxybenzoate (manufactured by Wako Pure Chemical Industries, Ltd.) was dissolved in 0.1 mL of ethanol. The volume average particle size of the obtained casein particles was measured with a “Zetasizer Nano” (manufactured by Sysmex) and was found to be 20.0 nm.

As described in Examples 1 to 7 above, water-dispersible nanoparticles containing a microbicide and a biodegradable polymer could be prepared.

### Test Example 1

The effect of the transdermal agent of the present invention was examined by measuring the hair growth-promoting action of hinokitiol.

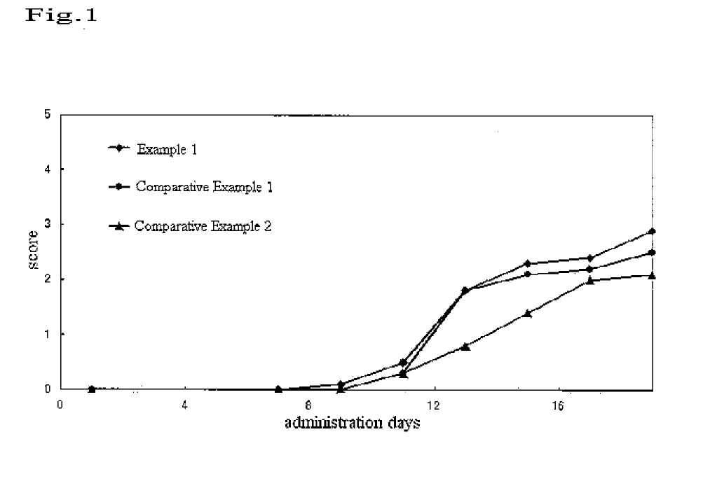

Dorsal hair of C3H mice at the trichogenous or dormant phase were cut with a hair clipper. On the next day, the mice were shaved with a shaver. The water dispersion of protein nanoparticles containing a hair growth-promoting agent prepared in Example 1 were applied to the entire shaved area once daily. The degree of ability to cause phase transition to the growth phase in mouse dorsal hair follicles was examined. As a result, when compared with the hinokitiol ethanol solution in an equal concentration (Comparative Example 1) and only casein nanoparticles wherein no hinokithiol was used in Example 1 (Comparative Example 2), hair growth-promoting effects were promoted and activity of causing hair cycle transition from the dormant phase to the growth phase was observed. The results are shown in FIG. 1. The score on the vertical axis of FIG. 1 is obtained by evaluating the shaved area (approximately 3×5 cm) based on the evaluation standard as described below, on the initial day of administration (the 1^{st} day), before administration on day 7, 9, 11, 13, 15 and 17, and the final observation day (the 19^{th} day).

TABLE 1
Determination item: Evaluation

| | |
|---|---|
| Skin becomes pink (100%) | 0 |
| Skin is changed to gray color (less than 50%) | 1 |
| Skin is changed to gray color (50% or more) and/or hair is growing | 2 |
| (less then 50%) | |
| Skin is changed to gray color (50% or more) and/or hair is growing | 3 |
| (50% or more to less than 80%) | |
| Hair is clearly growing (80% or more to less than 100%) | 4 |
| Hair is clearly growing (100%) | 5 |

From the results as shown in FIG. 1, it became clear that a transdermal agent, which does not cause excessive skin degreasing or skin irritation due to ethanol and exhibits good hair growth-promoting effects, could be produced.

1. A water-dispersible nanoparticle, which comprises a microbicide and a biodegradable polymer.

2. The nanoparticle according to claim 1, wherein the content of the microbicide is 0.1% to 100% by weight with respect to the weight of the biodegradable polymer.

3. The nanoparticle according to claim 1 wherein the average particle size is 10 to 1000 nm.

4. The nanoparticle according to claim 1, wherein the microbicide is an ionic substance or a fat-soluble substance.

5. The nanoparticle according to claim 4, wherein the microbicide is a cosmetic component, a functional food component, a quasi-drug component, or a pharmaceutical product component.

6. The nanoparticle according to claim 1, wherein the microbicide is at least one selected from the group consisting of hinokitiol, phenoxyethanol, thymol, cineole, isopropylmethylphenol, and methyl paraoxybenzoate.

7. The nanoparticle according to claim 1, wherein the biodegradable polymer is a protein.

8. The nanoparticle according to claim 7, wherein the protein is at least one selected from the group consisting of collagen, gelatin, acid-treated gelatin, albumin, ovalbumin, casein, sodium casein, transferrin, globulin, fibroin, fibrin, laminin, fibronectin, and vitronectin.

9. The nanoparticle according to claim 7, wherein the protein is subjected to a crosslinking treatment during and/or after nanoparticle formation.

10. The nanoparticle according to claim 9, wherein a transglutaminase is used for the crosslinking treatment.

11. A casein nanoparticle which is prepared by the following steps (a) to (c) of:
(a) mixing casein with a basic aqueous medium at a pH of from 8 to less than 11;
(b) adding at least one microbicide to the solution obtained in step (a); and
(c) injecting the solution obtained in step (b) into an acidic aqueous medium at a pH of 3.5 to 7.5.

12. A casein nanoparticle which is prepared by the following steps (a) to (c) of:
(a) mixing casein with a basic aqueous medium at a pH of from 8 to less than 11;
(b) adding at least one microbicide to the solution obtained in step (a); and
(c) decreasing the pH of the solution obtained in the step (b) to a pH value that is pH 1 or more away from the isoelectric point, while stirring the solution.

13. A drug delivery agent which comprises the nanoparticle of claim 1.
